(19) United States
(12) Patent Application Publication
(10) Pub. No.: US 2026/0257620 A1
(43) Pub. Date: Sep. 3, 2026

(54) METHODS, SYSTEMS, AND DEVICES FOR DETECTING A VEHICLE LAMP FAILURE

(71) Applicant: Toyota Motor Engineering & Manufacturing North America, Inc., Plano, TX (US)

(72) Inventors: Michael R. Kushnerik, Canton, MI (US); Timothy Wang, Ann Arbor, MI (US); Roger Akira Kyle, Aubrey, TX (US); Bryan Else Yamasaki, Aubrey, TX (US); Justin K. Shen, Canton, MI (US); Xiao Xu, Novi, MI (US); Jackson Zhu, Plano, TX (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 19/066,872

(22) Filed: Feb. 28, 2025

(51) Int. Cl. B60Q 11/00

(52) U.S. Cl. CPC B60Q 11/007

(57) ABSTRACT

Methods, systems, and devices for a vehicle lamp failure detection system for a vehicle. The system may include a plurality of vehicle lamps coupled to a vehicle configured to illuminate a plurality of different areas exterior to the vehicle. The system may include one or more external cameras configured to capture an expected or anticipated illumination area of the plurality of vehicle lamps. The system may include an electronic control unit (ECU). The ECU may determine at least one of the plurality of vehicle lamps is activated and determine the at least one of the plurality of vehicle lamps is not illuminating the expected or anticipated illumination area based on the captured expected or anticipated illumination area of the plurality of vehicle lamps from the one or more external cameras.

### BACKGROUND

### 1. Field

The present disclosure relates to methods, systems, and/or devices for detecting a failure of a vehicle lamp or light.

### 2. Description of the Related Art

Currently, some exterior lamps of vehicles offer outage detection. For example, current vehicles may determine a vehicle lamp outage by measuring the current consumed by the lamp while activated and judging if there is a circuit failure or internal lamp failure based on a set current threshold. However, the additional hardware used to implement this current measurement detection can be expensive, which limits adoption to only mandatory (usually regulated) lamps.

Accordingly, it is desirable to provide improved methods, systems, and devices for detecting a failure of a vehicle lamp.

### SUMMARY

In general, one aspect of the subject matter described in this disclosure may be embodied in a vehicle lamp failure detection system for a vehicle. The vehicle lamp failure detection system may include a plurality of vehicle lamps coupled to the vehicle configured to illuminate a plurality of different areas exterior to the vehicle. The vehicle lamp failure detection system may include one or more external cameras configured to capture an expected or anticipated illumination area of the plurality of vehicle lamps. The vehicle lamp failure detection system may include an electronic control unit (ECU). The ECU may determine at least one of the plurality of vehicle lamps is activated and determine the at least one of the plurality of vehicle lamps is not illuminating the expected or anticipated illumination area based on the captured expected or anticipated illumination area of the plurality of vehicle lamps from the one or more external cameras.

In one aspect, the subject matter may be embodied in a method for determining a vehicle lamp failure. The method may include determining, via an electronic control unit (ECU) of a vehicle, at least one of a plurality of vehicle lamps is activated. The plurality of vehicle lamps is configured to illuminate a plurality of different areas exterior to the vehicle. The method may further include receiving, from one or more external cameras coupled to the vehicle, a plurality of images depicting an expected or anticipated illumination area of the plurality of vehicle lamps. The method may further include determining, via the ECU, at least one of the plurality of vehicle lamps is not illuminating the expected or anticipated illumination area based on the plurality of images depicting the expected or anticipated illumination area of the plurality of vehicle lamps from the one or more external cameras.

In one aspect, the subject matter may be embodied in a vehicle including a system for generating and transmitting a vehicle emergency message. The vehicle may include a plurality of vehicle lamps coupled to the vehicle configured to illuminate a plurality of different areas exterior to the vehicle. The vehicle may include one or more external cameras configured to capture an expected or anticipated illumination area of the plurality of vehicle lamps. The vehicle may include an electronic control unit (ECU). The ECU may determine at least one of the plurality of vehicle lamps is activated and determine the at least one of the plurality of vehicle lamps is not illuminating the expected or anticipated illumination area based on the captured expected or anticipated illumination area of the plurality of vehicle lamps from the one or more external cameras.

### BRIEF DESCRIPTION OF THE DRAWINGS

Other systems, methods, features, and advantages of the present disclosure will be apparent to one skilled in the art upon examination of the following figures and detailed description. Component parts shown in the drawings are not necessarily to scale and may be exaggerated to better illustrate the important features of the present disclosure. In the drawings, like reference numerals designate like parts throughout the different views.

FIG. 1 is a block diagram of an example vehicle lamp failure detection system for a vehicle according to an aspect of the disclosure.

FIG. 2 is a flow diagram of an example process for detecting a vehicle lamp failure according to an aspect of the disclosure.

FIG. 3 illustrates a top view of an example vehicle including the vehicle lamp failure detection system of FIG. 1 according to an aspect of the disclosure.

FIG. 4 is a flow diagram of an example process for controlling the vehicle lamp failure detection system of FIG. 1 according to an aspect of the disclosure.

### DETAILED DESCRIPTION

Disclosed herein are methods, systems, devices, and/or vehicles for implementing a vehicle lamp failure detection system. The vehicle lamp failure detection system may include one or more cameras coupled to a vehicle and one or more exterior vehicle lamps (e.g., headlights, taillights, reverse lights, turn signals, fog lights, brake lights, etc.) coupled to the vehicle. The vehicle lamp failure detection system may first check if any of the exterior vehicle lamps are activated (i.e., the lamp is turned on). The one or more cameras can capture an area of expected or anticipated illumination for the exterior vehicle lamps. The vehicle lamp failure detection system can decipher the difference between right and left headlights, turn signals, and reverse lights based on one or more of the a color, a blinking status, an intensity, a coverage area, a beam direction, a vehicle travelling direction, and/or a vehicle gear selector position. As an example, the color of the lamp can be, for example, white for reverse lights, white for headlights, red for brake lights, yellow for turn signal lights, and amber for fog lights. The vehicle lamp failure detection system can determine, based on the captured area of expected or anticipated illumination from the cameras, that one or more of the exterior vehicle lamps is not illuminating the expected or anticipated area, indicating a lamp failure. Once the lamp failure is detected, a warning may be issued to the driver of the vehicle to alert them of the specific lamp failure to ensure prompt repair and/or replacement.

Particular aspects of the subject matter described in this disclosure may be implemented to realize one or more of the following advantages. Failure of an exterior vehicle lamp can create a dangerous situation for occupants and other vehicles on the road. In most cases, the driver is not aware of the failure, which can result in the issue going unfixed for a long period of time. The system described herein can utilize the exterior camera systems implemented in most modern vehicles as an image-based method of detecting lamp outage or coverage based on the resulting lamp illumination seen by the camera. The system described herein does not utilize additional hardware for implementation as most vehicles have exterior (generally wide Field of View) camera systems installed for Advanced Driver Assistance System (ADAS) or Parking Support. The system described herein can utilize the existing exterior camera systems for verifying an exterior lamp is operating as intended once activated. The exterior cameras equipped on most modern vehicles may include a wide panoramic field of view, covering many exterior lamps.

The vehicle lamp failure detection system described herein may include a plurality of vehicle lamps coupled to a vehicle configured to illuminate a plurality of different areas exterior to the vehicle. The vehicle lamp failure detection system may include one or more external cameras configured to capture an expected or anticipated illumination area of the plurality of vehicle lamps. The vehicle lamp failure detection system may include an electronic control unit (ECU). The ECU may determine at least one of the plurality of vehicle lamps is activated and determine the at least one of the plurality of vehicle lamps is not illuminating the expected or anticipated illumination area based on the captured expected or anticipated illumination area of the plurality of vehicle lamps from the one or more external cameras.

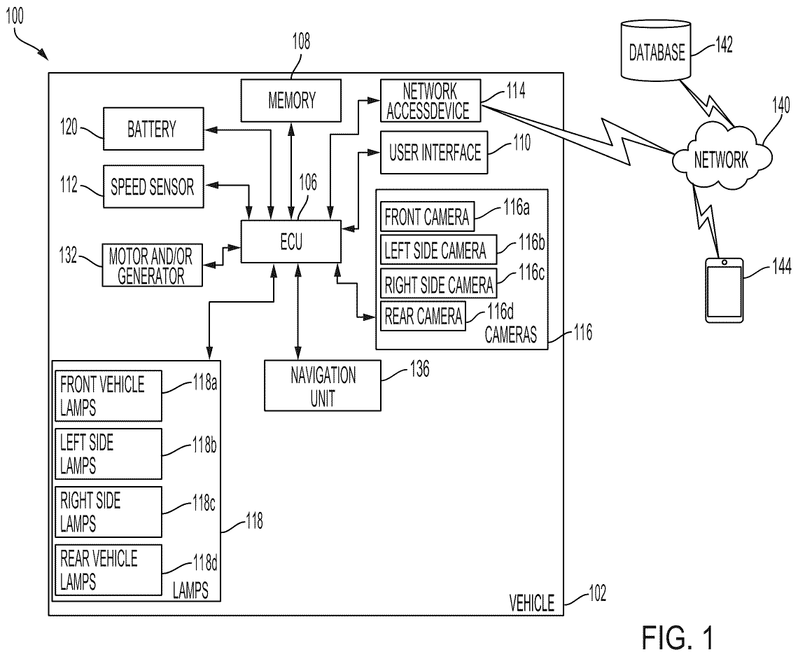

FIG. 1 is a block diagram for an example vehicle lamp failure detection system 100. The vehicle lamp failure detection system 100 or a portion thereof may be retrofitted, coupled to, include, or be included within a vehicle 102 or separate from the vehicle 102. The vehicle 102 may be a conveyance capable of transporting a person, an object, or a permanently or temporarily affixed apparatus. The vehicle 102 may be a self-propelled wheeled conveyance, such as a car, a sports utility vehicle, a truck, a bus, a van, a motorcycle, or other motor, battery, or fuel cell driven vehicle. For example, the vehicle 102 may be an electric vehicle, a hybrid vehicle, a plug-in hybrid vehicle, a hydrogen fuel cell vehicle, or any other type of vehicle that has a fuel cell, a motor, an engine, and/or a generator. Other examples of vehicles include bicycles, trains, planes, or boats, and any other form of conveyance that is capable of transportation. The vehicle 102 may be semi-autonomous or autonomous. That is, the vehicle 102 may be self-maneuvering and navigate without human input. An autonomous vehicle may have and use one or more sensors and/or a navigation unit to drive autonomously.

The vehicle lamp failure detection system 100 and/or the vehicle 102 may include a motor and/or generator 132 and/or a battery 120. The motor and/or generator 132 may be located within an engine bay of the vehicle 102. For example, the motor and/or generator 132 may be an internal combustion engine (ICE). In this regard, the motor and/or generator 132 may combust an air and fuel mixture to provide power to the vehicle 102 and/or components of the vehicle 102 and/or the vehicle lamp failure detection system 100. Accordingly, the motor and/or generator 132 can cause the vehicle 102 to accelerate, decelerate, or maintain a desired velocity. The motor and/or generator 132 may include combinations of an ICE and an electric motor, such as for hybrid electric vehicle (HEV) applications, for example. In examples, the motor and/or generator 132 may be an electric motor, such as for battery electric vehicle (BEV) applications, for example. In this regard, the motor and/or generator 132 may be an electric motor and an electric generator that converts electrical energy into mechanical power, such as torque, and converts mechanical power into electrical energy. The motor and/or generator 132 may be electrically connected to the battery 120. The motor and/or generator 132 may convert energy from the battery 120 into mechanical power, and may provide energy back to the battery 120, for example, via regenerative braking. The battery 120 may be electrically connected to the motor and/or generator 132 and may provide electrical energy to and/or receive electrical energy from the motor and/or generator 132. The battery 120 may provide electrical energy to the vehicle lamp failure detection system 100.

The vehicle lamp failure detection system 100 and/or the vehicle 102 may further include one or more processors, such as an electronic control unit (ECU) 106. The ECU 106 may be implemented as a single ECU or in multiple ECUs. The ECU 106 may be electrically connected to some or all of the components of the vehicle 102 and/or the vehicle lamp failure detection system 100 (e.g., via a controller area network (CAN) bus and/or other protocols). For example, the ECU 106 may be electrically connected to the motor and/or generator 132, the battery 120, a memory 108, a user interface 110, a network access device 114, a navigation unit 136, a speed sensor 112, one or more cameras 116, and/or one or more vehicle lamps 118. The ECU 106 may include one or more processors (or controllers) specifically designed for controlling operations of the vehicle 102, such as accelerating, braking, autonomous driving, parking (or parking assistance), etc. Moreover, the ECU 106 may control a panoramic view monitor (PVM) of the vehicle 102 (e.g., including the user interface 110 and/or the one or more cameras 116). In examples, the ECU 106 may be and/or include an ADAS sensor fusion ECU, a PVM ECU, an engine control module (ECM), a transmission control module (TCM), a telematics control unit (TCU), an inertial measurement unit (IMU), an in-vehicle infotainment (IVI) ECU, a graphics processing unit (GPU), and/or an artificial intelligence (AI) chip or processor.

The vehicle lamp failure detection system 100 may further include the memory 108. The memory 108 may be electrically connected to the ECU 106. In examples, the memory 108 may be communicatively coupled (e.g., via a network 140 and/or the network access device 114) to the ECU 106 such that the memory 108 is remote from the ECU 106 and/or the vehicle 102. In other examples, the memory 108 may be electrically connected to the ECU 106 and a remote memory (e.g., a remote database 142) may be communicatively coupled to the ECU 106, with the remote memory having similar, additional, and/or different functions as the memory 108 (e.g., greater storage capacity, enabling over-the-air updates, etc.). The memory 108 may store instructions to execute on the ECU 106 and may include one or more of a random access memory (RAM) or other volatile or non-volatile memory. The memory 108 may be a non-transitory memory or a data storage device, such as a hard disk drive, a solid-state disk drive, a hybrid disk drive, or other appropriate data storage, and may further store machine-readable instructions, which may be loaded and executed by the ECU 106. The memory 108 may store vehicle parameters (e.g., a weight of the vehicle 102, dimensions of the vehicle 102, transmission gear information of the vehicle 102, etc.).

The vehicle lamp failure detection system 100 may further include the user interface 110. The user interface 110 may be located within a cabin of the vehicle 102 (e.g., coupled to a dashboard of the vehicle 102). The user interface 110 may provide an interface to a user of the vehicle 102 (e.g., a driver and/or a passenger of the vehicle 102) to interact with and/or receive output from the ECU 106. The user interface 110 may have a user interface element, such as a screen and/or a touchscreen with a button, a switch, a microphone, a speaker, a gesture monitoring sensor, a knob, a graphical user interface (GUI), and/or other input/output devices electrically connected to the ECU 106 to provide input and/or output of information (or data) to and/or from the ECU 106.

The vehicle lamp failure detection system 100 may further include the network access device 114. The network access device 114 may be electrically connected to the ECU 106 and may include a communication port or channel, such as one or more of a Wi-Fi unit, a Bluetooth® unit, a Radio Frequency Identification (RFID) tag or reader, a Dedicated Short Range Communications (DSRC) unit, a satellite network unit, and/or a cellular network unit for accessing the network 140 (e.g., CDMA, GSM, 3G, 4G, 5G, etc.). The network access device 114 may transmit data to and receive data from devices and systems not directly connected to the vehicle 102. For example, the ECU 106 may communicate with the remote database 142 and/or a user device 144 (e.g., a mobile device, a phone, a tablet, a laptop, etc.) through the network access device 114.

The vehicle lamp failure detection system 100 may further include the navigation unit 136. The navigation unit 136 may be electrically connected to the ECU 106 and may provide vehicle information (or data) and/or navigational map information to the ECU 106. The navigation unit 136 may include and/or be connected to a Global Positioning System (GPS) device. The vehicle information may include a current position and/or location of the vehicle 102, a current time at the current position, a direction of travel, and/or a current speed of the vehicle 102. In examples, the navigation unit 136 may provide the vehicle information (e.g., indicating the current speed of the vehicle 102) to the ECU 106. The ECU 106 and/or the navigation unit 136 may determine the current speed of the vehicle 102 (e.g., in miles per hour (MPH) and/or kilometers per hour (KPH)) based on the vehicle information.

The vehicle lamp failure detection system 100 may further include the speed sensor 112. In examples, the vehicle lamp failure detection system 100 may include a plurality of speed sensors. The speed sensor 112 may be electrically connected to the ECU 106. The speed sensor 112 may be configured to measure, detect, and/or determine the current speed of the vehicle 102. For example, the speed sensor 112 may be and/or include an electronic vehicle speed sensor (e.g., that measures rotation of the motor and/or generator 132 and/or a transmission shaft of the vehicle 102) and/or one or more wheel speed sensors (e.g., that measure rotation of one or more wheels of the vehicle 102). In examples, the speed sensor 112 may provide speed data indicating the current speed of the vehicle 102 to the ECU 106. The ECU 106 and/or the speed sensor 112 may determine the current speed of the vehicle 102 (e.g., in miles per hour (MPH) and/or kilometers per hour (KPH)) based on the speed data.

The vehicle lamp failure detection system 100 may further include the one or more cameras 116. The one or more cameras 116 may be coupled to an exterior of the vehicle 102 and/or an interior of the vehicle 102 such that the one or more cameras 116 look out toward a surrounding area of the vehicle 102. The one or more cameras 116 may be and/or include one or more of an analog camera, a digital camera, a thermal camera, and/or a night vision camera (e.g., utilizing active illumination and/or image intensification). The one or more cameras 116 may provide, capture, and/or record images and/or real-time video of the surrounding area of the vehicle 102. In examples, the one or more cameras 116 (e.g., via the ECU 106) may also have pattern recognition capabilities to view the surrounding area and identify, for example, vehicles, components of vehicles (e.g., a license plate, a side view mirror, vehicle lamps, etc.), road signs (e.g., speed limit signs), and/or writing (e.g., letters, numbers, symbols, etc.) on the vehicles and/or the road signs. The one or more cameras 116 may include one or more front cameras 116a, one or more left side cameras 116b, one or more right side cameras 116c, and/or one or more rear cameras 116d.

The one or more front cameras 116a may be coupled to or integrated into a front end of the vehicle 102, such as a front bumper and/or a windshield, for example. In examples, the one or more front cameras 116a may include a plurality of front cameras (e.g., with each having a different field of view, orientation, and/or location on the vehicle 102). The one or more front cameras 116a may provide, capture, and/or record real-time video of a forward field of view with respect to the vehicle 102 (e.g., a portion of the surrounding area of the vehicle 102 that is in front of the vehicle 102).

The one or more left side cameras 116b may be coupled to a left side of the vehicle 102, such as a left side mirror, a left front quarter panel (or fender), a left rear quarter panel (or fender), a left side door, etc. In examples, the one or more left side cameras 116b may include a plurality of left side cameras (e.g., with each having a different field of view, orientation, and/or location on the vehicle 102). The one or more left side cameras 116b may provide, capture, and/or record real-time video of a leftward field of view with respect to the vehicle 102 (e.g., a portion of the surrounding area of the vehicle 102 that is to the left of the vehicle 102).

The one or more right side cameras 116c may be coupled to or embedded into a right side of the vehicle 102, such as a right side mirror, a right front quarter panel (or fender), a right rear quarter panel (or fender), a right side door, a front windshield, a right window, etc. In examples, the one or more right side cameras 116c may include a plurality of right side cameras (e.g., with each having a different field of view, orientation, and/or location on the vehicle 102). The one or more right side cameras 116c may provide, capture, and/or record real-time video of a rightward field of view with respect to the vehicle 102 (e.g., a portion of the surrounding area of the vehicle 102 that is to the right of the vehicle 102).

The one or more rear cameras 116d may be coupled to a rear end of the vehicle 102, such as a rear bumper, a rear window, a tailgate, and/or a liftgate, for example. In examples, the one or more rear cameras 116d may include a plurality of rear cameras (e.g., with each having a different field of view, orientation, and/or location on the vehicle 102). The one or more rear cameras 116d may provide, capture, and/or record real-time video of a rearward field of view with respect to the vehicle 102 (e.g., a portion of the surrounding area of the vehicle 102 that is behind the vehicle 102).

The vehicle lamp failure detection system 100 may further include the one or more vehicle lamps 118. The one or more vehicle lamps 118 may be, for example, one or more of a headlight, a taillight, a fog light, a daytime running light, an accent light, a turn signal, a spotlight, a reverse light, and/or an accessory light. The one or more vehicle lamps 118 may illuminate an area surrounding the vehicle. A location of each of the one or more vehicle lamps 118 on the vehicle 102 may be known to the ECU 106 (e.g., the location of each of the one or more vehicle lamps 118 may be stored in or on the memory 108).

The one or more vehicle lamps 118 may include one or more front vehicle lamps 118a, one or more left side vehicle lamps 118b, one or more right side vehicle lamps 118c, and/or one or more rear vehicle lamps 118d. The one or more front vehicle lamps 118a may be coupled to or embedded into the front end of the vehicle 102, such as the front bumper and/or the windshield, for example. In examples, the one or more front vehicle lamps 118a may be headlights of a vehicle 102.

The one or more left side vehicle lamps 118b may be coupled to or embedded into the left side of the vehicle 102, such as the left side mirror, the left front quarter panel (or fender), the left rear quarter panel (or fender), the left side door, a left windshield, a left window, etc. In examples, the one or more left side vehicle lamps 118b may be a left turn signal.

The one or more right side vehicle lamps 118c may be coupled to or embedded into the right side of the vehicle 102, such as the right side mirror, the right front quarter panel (or fender), the right rear quarter panel (or fender), the right side door, a front windshield, a right window, etc. In examples, the one or more right side vehicle lamps 118c may be a right turn signal.

The one or more rear vehicle lamps 118d may be coupled to or embedded into the rear end of the vehicle 102, such as the rear bumper, the rear window, the tailgate, and/or the liftgate, for example. In examples, the one or more rear vehicle lamps 118d may be brake lights.

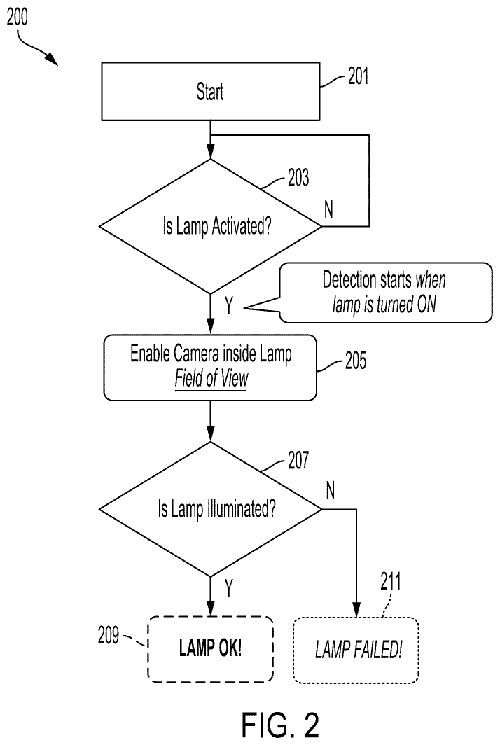

FIG. 2 is a flow diagram of an example process 200 for detecting a vehicle lamp failure according to an aspect of the disclosure. The process 200 may begin at block 201 when the process 200 is initiated. The process 200 may be initiated by a turning on of the vehicle. In other aspects, the process 200 may be initiated ad-hoc by a user. For example, a user may turn on the lamp detection failure feature in their vehicle as desired.

At block 203, the system may determine if a vehicle lamp is activated. If a lamp is not activated, the process 200 returns to the start to continue to monitor if a lamp is activated. A lamp may be activated when a user turns the lamp on, or the lamp is automatically turned on based on certain settings. For example, the lamp may automatically turn on when the vehicle determines it is nighttime or current conditions require the lamp to turn on (e.g., dense fog, rain, snow, tunnel, etc.). For a turn signal lamp, the lamp may be activated when the driver engages the right or left turn signal (e.g., via a button, turn signal lever, turn signal switch, etc.) or when an autonomous vehicle switches lanes. For a brake light, the lamp may be activated when the driver presses on the brake pedal. In addition, for autonomous driving or when using adaptive cruise control, the brake light lamp may be activated when the vehicle slows down or otherwise engages the brake. In addition, for electric vehicles, the brake light lamp may be activated when the vehicle engages regenerative braking. If the lamp is activated, the system can begin detecting for lamp illumination.

If the lamp is activated, the process 200 may proceed to block 205, where the system can enable a camera with a field of view including the lamp. The field of view is the visible area that can be seen through the lens of the camera. Therefore, the system can enable a camera whose visible area that can be seen through its lens includes the activated lamp. The camera can therefore, once enabled, capture images of the activated lamp.

At block 207, the system can determine if the lamp is illuminated. The system may use the captured images from the camera to identify whether or not the lamp is illuminated. For example, the images from the camera may show that there is no light being emitted from the lamp. In another example, the images from the camera may show that the light from the lamp is obstructed by an object or other obstruction, such as rain, snow, ice, dirt, fog, etc. Additionally, the images from the camera may also show that the lamp has experienced damage or malfunction, such as broken bulbs, cracked or broken lens covers, misaligned headlights, flickering lights (which may indicate faulty wiring), discolored lenses, dim lights, or other lamp instability. On the other hand, the images from the camera may show that the lamp is illuminating an expected or anticipated area and therefore, functioning properly. If the lamp is illuminating as expected or anticipated, at block 209, the system can determine the lamp is ok but can alert or notify the driver that the lamp or devices associate with the lamp are damaged or broken. Otherwise, at block 211, the system can determine the lamp is experiencing a failure.

Optionally, once the lamp failure is detected, a warning may be issued to the driver of the vehicle to alert them of the lamp failure to ensure prompt repair and/or replacement. The alert may be displayed via a pop up, meter, multimedia screen (such as a display or infotainment system), or other customer facing device. The warning may include information about the damage, failure and/or about the lamp that is experiencing the failure. This information may include, for example, type of damage or failure (e.g., broken bulbs, cracked or broken lens covers, misaligned headlights, flickering lights (which may indicate faulty wiring), discolored lenses, dim lights, light is not illuminated, light is obstructed (by object, snow, ice, dirt, fog, etc.), location of the failed lamp, part number of the failed lamp, instructions for how to fix the failed lamp, or instructions for how to make an appointment to fix the failed lamp. The system may optionally provide the user with options for locations to purchase the replacement lamp or part. For example, the system may display available purchase locations on a vehicle infotainment system map or send the user pinned locations for available purchase locations for the replacement part to the user's phone. The system may optionally prompt the user to make an appointment to fix the failed lamp (e.g., via a vehicle infotainment system or by sending a link to the user's phone or device).

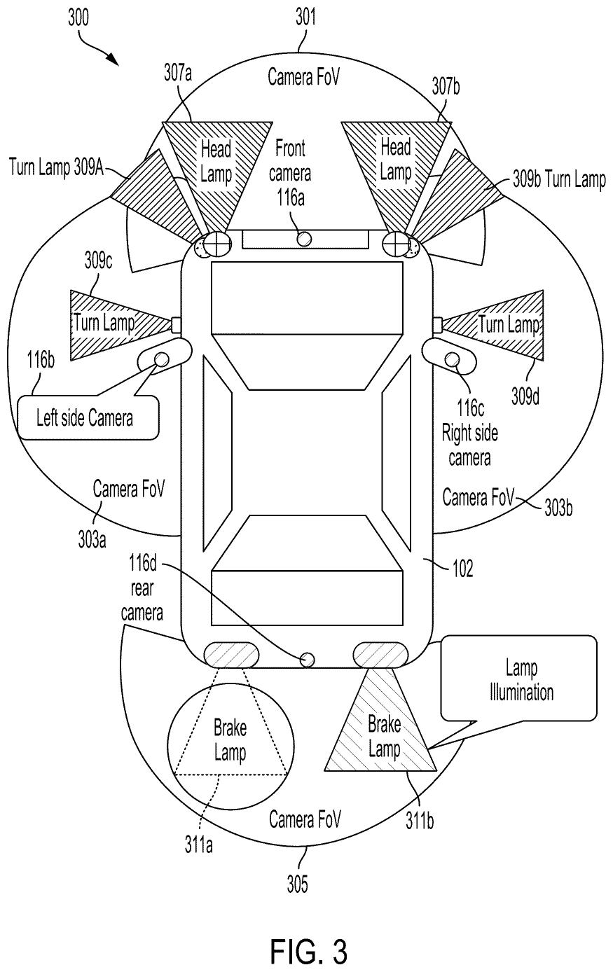

FIG. 3 illustrates a top view 300 of an example vehicle 102 which may include the vehicle lamp failure detection system 100 of FIG. 1 according to an aspect of the disclosure. The vehicle lamp failure detection system 100 may have a plurality of camera fields of view. For example, the plurality of fields of view may include one or more front fields of view 301, one or more left side fields of view 303a, one or more right side fields of view 303b, and/or one or more rear fields of view 305. The plurality of fields of view 301, 303a-b, and 305 may each correspond to a respective camera of the one or more cameras 116. Accordingly, each of the one or more cameras 116 may have a respective field of view of the plurality of fields of view 301, 303a-b, and 305.

For example, the one or more front cameras 116a may have the one or more front fields of view 301, the one or more left side cameras 116b may have the one or more left side fields of view 303a, the one or more right side cameras 116c may have the one or more right side fields of view 303b, and/or the one or more rear cameras 116d may have the one or more rear fields of view 305. Although FIG. 3 illustrates a front field of view 301, a left side field of view 303a, a right side field of view 303b, and a rear field of view 305, the vehicle lamp failure detection system 100 may have any number of front, left side, right side, and/or rear fields of view (e.g., based on a quantity of cameras of the one or more cameras 116). In examples, the plurality of fields of view 301, 303a-b, and 305 may have a different location and/or shape than what is illustrated in FIG. 3 (e.g., the one or more cameras 116 may be positioned at different locations on the vehicle 102 and/or may have different orientations).

The plurality of fields of view 301, 303a-b, and 305 may be or correspond to a detection range and/or area of the one or more cameras 116 and/or a field of view of the one or more cameras 116. In examples, the plurality of fields of view 301, 303a-b, and 305 may have a rectangular shape and/or a circular shape (in examples, the plurality of fields of view 301, 303a-b, and 305 may have one or more different shapes). The plurality of fields of view 301, 303a-b, and 305 may have a range of less than or equal to 60 degrees, 80 degrees, and/or 110 degrees, for example (in examples, the range may be any other degree, such as more than 110 degrees). The range and/or dimensions of each of the plurality of fields of view 301, 303a-b, and 305 may be known to the ECU 106.

Within the plurality of fields of view 301, 303a-b, and 305 may be one or more vehicle lamps. For example, the front field of view 301 may include the headlamps 307a and 307b, the turn lamps 309a and 309b. The left side field of view 303a may include the turn lamps 309a and 309c. The right side field of view 303b may include the turn lamps 309b and 309d. The rear camera field of view 305 may include the brake lamps 311a and 311b.

Each of the respective cameras associated with the fields of view can capture images of the lamps within the given field of view. For example, the front field of view 301 can capture images of the headlamps 307a and 307b and the turn lamps 309a and 309b using the front camera 116a. The left side field of view 303a can capture images of the turn lamps 309a and 309c using the left side camera 116b. The right side field of view 303b can capture images of the turn lamp 309b and 309d using the right side camera 116c. The rear field of view 305 can capture images of the brake lamps 311a and 311b. Using these images from the cameras 116 the system can determine whether or not a vehicle lamp is illuminated. For example, the rear camera 116d can capture images depicting that the brake lamp 311a is not illuminating. The one or more cameras 116 may also capture other malfunctions with the lamps or an obstruction of a lamp, as discussed in further detail above with respect to FIG. 2.

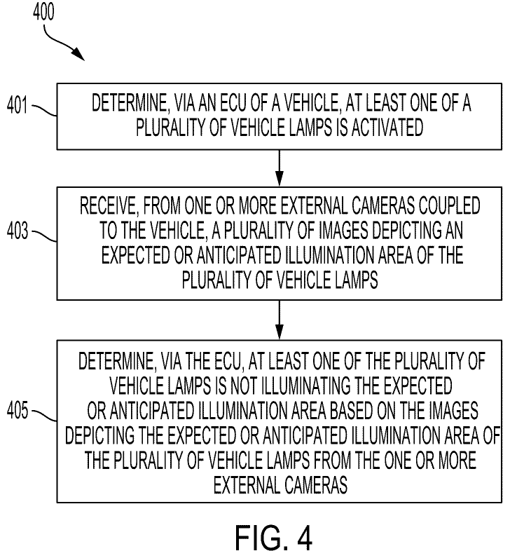

FIG. 4 is a flow diagram of an example process 400 for controlling the vehicle lamp failure detection system 100 of FIG. 1 according to an aspect of the disclosure. One or more computers or one or more data processing apparatuses, for example, the ECU 106 of the vehicle lamp failure detection system 100 of FIG. 1, appropriately programmed, may implement the process 400. For ease of description, the process 400 is described below with reference to FIGS. 1-3. The process 400 of the present disclosure, however, is not limited to use of the exemplary vehicle lamp failure detection systems of FIGS. 1-3.

At block 401, the vehicle lamp failure detection system 100 may determine, via the ECU 106 of the vehicle 102, at least one of the plurality of vehicle lamps 118 is activated. In examples, the ECU 106 may determine at least one of the plurality of vehicle lamps 118 is activated based whether one of the plurality of vehicle lamps 118 is turned on. The ECU 106 may determine one of the plurality of vehicle lamps 118 is turned on based on a lamp power switch, a triggered turn signal, vehicle brake is pressed, etc.

At block 403, the vehicle lamp failure detection system 100 may further receive, from the one or more cameras 116 coupled to the vehicle 102, a plurality of images depicting an expected or anticipated illumination area of the plurality of vehicle lamps 118. The expected or anticipated illumination area of the plurality of vehicle lamps 118 may include an area surrounding each of the plurality of vehicle lamps 118 where the lamp is expected or anticipated to illuminate. In examples, the expected or anticipated illumination area may have a cone shape and/or a cylindrical shape (in examples, the expected or anticipated illumination area may have one or more different shapes) extending out from the vehicle lamp. For example, the expected or anticipated illumination area may have a vertical angle (e.g., corresponding to a vertical beam angle of the one or more lamps 118) of 10-30 degrees (in examples, the vertical angle may be less than 10 degrees or more than 30 degrees). In addition, the expected or anticipated illumination area may have a horizontal angle (e.g., corresponding to a horizontal beam angle of the one or more lamps 118) of 30-120 degrees (in examples, the horizontal angle may be less than 30 degrees or more than 120 degrees). The expected or anticipated illumination area may have a range of less than or equal to 10 feet, 25 feet, and/or 100 feet, for example (in examples, the range may be any other distance, such as more than 100 feet). The range, a position relative to the vehicle 102, and/or dimensions of each of the expected or anticipated illumination area may be known to the ECU 106.

The vehicle lamp failure detection system 100 may further determine, via the ECU 106, at least one of the plurality of vehicle lamps 118 is not illuminating the expected or anticipated illumination area based on the images depicting the expected or anticipated illumination area of the plurality of vehicle lamps 118 from the one or more external cameras 116. The expected or anticipated illumination area of the plurality of vehicle lamps 118 captured in the images from the one or more external cameras 116 may depict each illumination area of the plurality of vehicle lamps. For example, the captured illumination area may be an image depicting a rear brake light and the expected area of illumination in front of the brake light. The image may further depict that there is no illumination in the expected area of illumination in front of the brake light. Therefore, the vehicle lamp failure detection system 100 can determine that the rear brake light is not illuminating the expected or anticipated illumination area. The image may further depict that the rear brake light is blocked by a layer of snow. Therefore, the vehicle lamp failure detection system 100 may also determine that the cause of the failure to illuminate the expected or anticipated illumination area is the layer of snow. The vehicle lamp failure detection system 100 may also alert or notify the driver of the cause of the failure.

In examples, the vehicle lamp failure detection system 100 may determine that a vehicle lamp is not illuminating the expected or anticipated illumination area based on a specified threshold. The threshold may be an amount of expected illumination or brightness of the lamp. For example, the threshold may be a number of expected luminous intensity, such as a certain number of candelas or lumens. If the vehicle lamp failure detection system 100 determines the luminous intensity of the lamp is above or below the threshold, the system may determine that the lamp is experiencing a failure.

In addition or alternatively, in examples, the threshold margin may be the numerical value and/or the percentage of the expected luminous intensity and may be based on one or more conditions of the road and/or one or more weather conditions. For example, the threshold margin may be lower when it is raining or snowing, and/or when visibility is low due to rain, snow, fog, or dust, which can impact an otherwise properly functioning lamp's luminosity.

In examples, the cameras 116 can also decipher the difference between right and left headlights, turn signals, and reverse lights based on the color, the blinking status, the intensity, the coverage area, the beam direction, the vehicle travelling direction, and/or the vehicle gear selector position. In this case, the vehicle lamp failure detection system 100 may alter the determination of illumination for a lamp based on the type of light deciphered. For example, a turn signal may have a different expected level of luminosity than a headlight.

In examples, the vehicle lamp failure detection system 100 may transmit, via the network access device 114 electrically connected to the ECU 106, the image data and the determined failure of the one or more lamps 118 to the user device 144 and/or the remote database 142 when there is a determined failure.

In examples, once the lamp failure is detected, the vehicle lamp failure detection system 100 may issue a warning to the driver of the vehicle to alert them of the specific lamp failure to ensure prompt repair and/or replacement. The warning may appear in a pop up, meter, multimedia screen (such as a display or infotainment system), or other customer facing device to alert the user that a lamp is compromised or there is an outage detected, as further described above.

Exemplary aspects of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such aspects that reasonably fall within the scope of the advancement to the art hereby contributed, and that that scope shall not be restricted, except in light of the appended claims and their equivalents.

What is claimed is:

1. A system for determining a vehicle lamp failure, comprising:
a plurality of vehicle lamps coupled to a vehicle configured to illuminate a plurality of different areas exterior to the vehicle;
one or more external cameras configured to capture an expected or anticipated illumination area of the plurality of vehicle lamps; and
an electronic control unit (ECU) coupled to the vehicle and the one or more external cameras, and configured to:
determine at least one of the plurality of vehicle lamps is activated; and
determine the at least one of the plurality of vehicle lamps is not illuminating the expected or anticipated illumination area based on the captured expected or anticipated illumination area of the plurality of vehicle lamps from the one or more external cameras.

2. The system of claim 1, wherein the plurality of vehicle lamps comprise one or more of:
a turn lamp, a head lamp, or a brake lamp.

3. The system of claim 1, wherein the one or more external cameras comprise one or more of: an advanced driver assistance system camera, a parking support camera, or a panoramic view camera.

4. The system of claim 1, wherein the one or more external cameras are placed on the head of the vehicle, the tail of the vehicle, and the side view mirrors of the vehicle.

5. The system of claim 1, wherein to determine at least one of the plurality of vehicle lamps is activated, the ECU is further configured to:
receive an indication that at least one of: a vehicle turn signal has been turned on, a vehicle headlight has been turned on, or a vehicle brake pedal is pushed; and
determine, based on the indication, that at least one of the plurality of vehicle lamps is activated.

6. The system of claim 1, wherein not illuminating the expected or anticipated illumination area comprises one or more of: lamp is not illuminated, lamp is partially illuminated, lamp is obstructed, lamp is damaged, or lamp has low intensity illumination.

7. The system of claim 1, wherein the ECU is further configured to: determine the at least one of the plurality of vehicle lamps is obstructed based on the captured expected or anticipated illumination area of the plurality of vehicle lamps from the one or more external cameras.

8. The system of claim 1, further comprising a memory coupled to the ECU for storing a plurality of specifications of each of the plurality of vehicle lamps.

9. The system of claim 1, further comprising:
a display configured to display an alert to a driver of the vehicle that the at least one of the plurality of vehicle lamps is not illuminating the expected or anticipated illumination area.

10. The system of claim 9, wherein the alert provides an indication as to the part number of the at least one of the plurality of vehicle lamps not illuminating the expected or anticipated illumination area.

11. The system of claim 1, wherein the ECU is further configured to decipher the difference between right and left headlights, turn signals, and reverse lights based on at least one of a color, a blinking status, an intensity, a coverage area, a beam direction, a vehicle travelling direction, or a vehicle gear selector position.

12. A method for determining a vehicle lamp failure, the method comprising:
determining, via an electronic control unit (ECU) of a vehicle, at least one of a plurality of vehicle lamps is activated, the plurality of vehicle lamps configured to illuminate a plurality of different areas exterior to the vehicle;
receiving, from one or more external cameras coupled to the vehicle, a plurality of images depicting an expected or anticipated illumination area of the plurality of vehicle lamps; and
determining, via the ECU, at least one of the plurality of vehicle lamps is not illuminating the expected or anticipated illumination area based on the plurality of images depicting an expected or anticipated illumination area of the plurality of vehicle lamps from the one or more external cameras.

13. The method of claim 12, wherein determining at least one of the plurality of vehicle lamps is activated comprises:
receiving an indication that at least one of: a vehicle turn signal has been turned on, a vehicle headlight has been turned on, or a vehicle brake pedal is pushed; and
determining, based on the indication, that at least one of the plurality of vehicle lamps is activated.

14. The method of claim 12, wherein not illuminating the expected or anticipated illumination area comprises one or more of: lamp is not illuminated, lamp is partially illuminated, lamp is obstructed, lamp is damaged, or lamp has low intensity illumination.

15. The method of claim 12, further comprising storing, via a memory coupled to the ECU, a plurality of specifications of each of the plurality of vehicle lamps.

16. The method of claim 12, further comprising determining the at least one of the plurality of vehicle lamps is obstructed based on the plurality of images depicting the expected or anticipated illumination area of the plurality of vehicle lamps from the one or more external cameras.

17. The method of claim 12, further comprising:
displaying, via a vehicle display, an alert to a driver of the vehicle that the at least one of the plurality of vehicle lamps is not illuminating the expected or anticipated illumination area.

18. The method of claim 17, wherein the alert provides an indication as to the part number of the at least one of the plurality of vehicle lamps not illuminating the expected or anticipated illumination area.

19. The method of claim 12, further comprising deciphering, via the ECU, the difference between right and left headlights, turn signals, and reverse lights based on the color, blinking status, and intensity of the plurality of vehicle lamps and vehicle travelling direction.

20. A vehicle including a system for determining a vehicle lamp failure, the vehicle comprising:
a plurality of vehicle lamps coupled to the vehicle configured to illuminate a plurality of different areas exterior to the vehicle;
one or more external cameras configured to capture an expected or anticipated illumination area of the plurality of vehicle lamps; and
an electronic control unit (ECU) coupled to the vehicle and the one or more external cameras, and configured to:
determine at least one of the plurality of vehicle lamps is activated; and
determine the at least one of the plurality of vehicle lamps is not illuminating the expected or anticipated illumination area based on the captured expected or anticipated illumination area of the plurality of vehicle lamps from the one or more external cameras.
